(19) United States
(12) Patent Application Publication
(10) Pub. No.: US 2025/0382474 A1
(43) Pub. Date: Dec. 18, 2025

(54) SYSTEM AND METHOD FOR REMOVING PAINT FROM A SUBSTRATE

(71) Applicant: THE BOEING COMPANY, Arlington, VA (US)

(72) Inventors: Dominic Ndubueze Nwoke, Seattle, WA (US); Joseph Anton Pecina, Lynnwood, WA (US); Marc James Froning, Seattle, WA (US); Alexander Anthony Hicker, Kent, WA (US)

(73) Assignee: THE BOEING COMPANY, Arlington, VA (US)

(21) Appl. No.: 19/069,316

(22) Filed: Mar. 4, 2025

Related U.S. Application Data
(60) Provisional application No. 63/659,419, filed on Jun. 13, 2024.

(51) Int. Cl. C09D 5/00; C09D 5/22; C09D 7/40

(52) U.S. Cl. CPC C09D 5/008; C09D 5/22; C09D 7/67

(57) ABSTRACT

A method includes applying a primer applied on a surface of a substrate, applying a nano-particle layer over the primer, and applying a paint layer over the nano-particle layer. The method for removing the paint layer from the substrate includes emitting signals, by an energy source, into the substrate, exciting a nano-particle layer by the signals, generating heat by the nano-particle layer in response to said exciting, and removing the paint layer by the heat.

### CROSS-REFERENCE TO RELATED APPLICATION

This application relates to and claims priority benefits from U.S. Provisional Patent Application No. 63/659,419, filed Jun. 13, 2024, which is hereby incorporated by reference in its entirety.

### FIELD OF THE DISCLOSURE

Examples of the present disclosure generally relate to systems and methods for removing paint from a substrate.

### BACKGROUND OF THE DISCLOSURE

Various structures are painted. For example, an aircraft can include painted outer surfaces. Over time, the painted surfaces may degrade. For example, the paint can fade. As another example, the paint can be chipped if contacted by another object.

Accordingly, a structure may need to be repainted, if desired. Before being repainted, a previous layer of paint is typically removed, such as through laser ablation, manual sanding, or chemical stripping. Such removal processes are labor intensive, and can potentially cause damage to an underlying primer layer or surface over which the primer layer covers. Manual sanding can pose health and safety concerns. For example, vigorous manual sanding can cause ergonomic industries. Chemical stripping can utilize hazardous material. Laser ablation can generate significant heat, which can degrade a primer and underlying structure. Further, laser ablation may not remove an entire coating layer.

### SUMMARY OF THE DISCLOSURE

A need exists for an efficient and effective system and method for removing paint from a structure. Further, a need exists for a system and a method, which do not undesirably affect an underlying primer and structure.

With those needs in mind, certain examples of the present disclosure provide a system including a substrate having a surface. A primer is applied on the surface of the substrate. A nano-particle layer is applied over the primer. A paint layer is applied over the nano-particle layer.

In at least one example, the nano-particle layer includes a carrier, and nano-particles suspended within the carrier.

The substrate can be a structure of an aircraft.

The nano-particle layer can be applied over the primary by a spray gun.

In at least one example, the nano-particle layer is sandwiched between the primer and the paint layer.

In at least one example, the nano-particle layer is configured to be excited by signals emitted by an energy source. The nano-particle layer is further configured to generate heat when excited by the signals. The heat removes the paint layer (such as by disbonding the paint layer from the nano-particle layer). In at least one example, the heat generated by the nano-particle layer is directed toward and into the paint layer. In at least one further example, the heat generated by the nano-particle layer is directed away from the primer.

In at least one example, the nano-particle layer is further configured to fluoresce when excited by the signals. The paint layer is removed from the substrate when a fluorescence of the nano-particle layer is visible (such as to an observer viewing the substrate).

In at least one example, the energy source includes a radio frequency (RF) signal exciter, and the signals include radio waves.

Certain examples of the present disclosure provide a method including applying a primer applied on a surface of a substrate; applying a nano-particle layer over the primer; and applying a paint layer over the nano-particle layer.

Certain examples of the present disclosure provide a method for removing a paint layer from a substrate. The method includes emitting signals, by an energy source, into the substrate; exciting a nano-particle layer by the signals; generating heat by the nano-particle layer in response to said exciting; and removing the paint layer by the heat.

### BRIEF DESCRIPTION OF THE DRAWINGS

FIG. 1 illustrates a block diagram of a substrate.

FIG. 2 illustrates a block diagram of a primer being applied to the substrate, according to an example of the present disclosure.

FIG. 3 illustrates a block diagram of a nano-particle layer applied over the primer, according to an example of the present disclosure.

FIG. 4 illustrates a block diagram of a paint layer applied over the nano-particle layer, according to an example of the present disclosure.

FIG. 5 illustrates a block diagram of a radio frequency (RF) signal exciter coupled to a paint layer, according to an example of the present disclosure.

FIG. 6 illustrates a magnified perspective view of nano-particles, according to an example of the present disclosure.

FIG. 7 illustrates a flow chart of a method, according to an example of the present disclosure.

FIG. 8 illustrates a perspective front view of an aircraft.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

As described herein, a paint removal method includes applying a functional layer containing metallic nano-tube particles between a primer and a topcoat layer of paint, and activating the functional layer with an energy source, which generates heat, softening the topcoat layer of paint for removal. The system and method can be used to remove a paint layer from a substrate, which can be formed of a metal, a composite, and/or a plastic. An embedded nano-particle layer is deposited or otherwise applied between a primer and a paint. The nano-particle layer is or otherwise includes an organic coating containing metallic nano-particles, and provides a low cost, safe, and environmentally-friendly, conditions-based maintenance topcoat removal feature. In at least one example, the nano-particle layer includes a disbursed suspension of specifically tuned nano-particles in an organic paint which, when activated by excitation from signals output by an external high energy source, generate heat, which softens the adjacent topcoat paint layer, thereby simplifying removal of the topcoat paint layer. In at least one example, when activated, the nano-particle layer fluoresces, thereby providing a readily discernable indication that the topcoat paint layer has been removed.

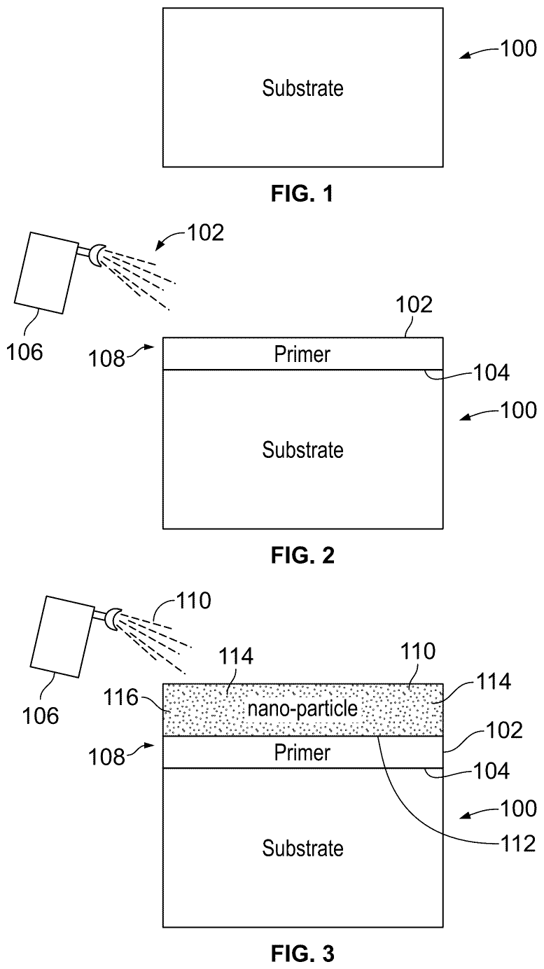

FIG. 1 illustrates a block diagram of a substrate 100. The substrate 100 can be a component, or a portion of a component. For example, the substrate 100 can be an outer skin layer of a portion of a vehicle, such as a commercial aircraft. The outer skin layer can form a portion of a fuselage, a wing, or the like. Optionally, the substrate 100 can be a portion of various other structures, such as a fixed structure (for example, a residential or commercial building). The substrate 100 can be formed of metal, a plastic, and/or a composite material. The substrate 100 is configured to be painted.

FIG. 2 illustrates a block diagram of a primer 102 being applied to the substrate 100, according to an example of the present disclosure. The primer 102 is applied to an exposed surface 104 of the substrate 100. For example, the exposed surface 104 is an outer surface of the substrate 100. In at least one example, the primer 102 is applied by spraying. For example, a spray gun 106 can be used to spray the primer 102 over the surface 104 of the substrate 100 to provide a layer 108 of the primer 102 over the surface 104 of the substrate 100. Optionally, the primer 102 can be applied via other processes, such as brushing, immersing, or the like.

FIG. 3 illustrates a block diagram of a nano-particle layer 110 applied over the primer 102, according to an example of the present disclosure. After the primer 102 is applied over the surface 104 of the substrate 100, the nano-particle layer 110 is applied over an exposed surface 112 of the primer 102. The nano-particle layer 110 can be applied by spraying. For example, the spray gun 106 can be used to spray the nano-particle layer 110 over the surface 112 of the primer 102. Optionally, the nano-particle layer 110 can be applied via other processes, such as brushing, immersing, or the like.

The nano-particle layer 110 includes nano-particles 114 suspended in a carrier 116. In at least one example, during application, the carrier 116 is in liquid or semi-liquid format. For example, the carrier 116 can be an organic paint. As another example, the carrier 116 can be primer. As another example, the carrier 116 can be water. As another example, the carrier 116 can be methyl ethyl ketone (MEK). The carrier 116 dries over the layer 108 of the primer 102.

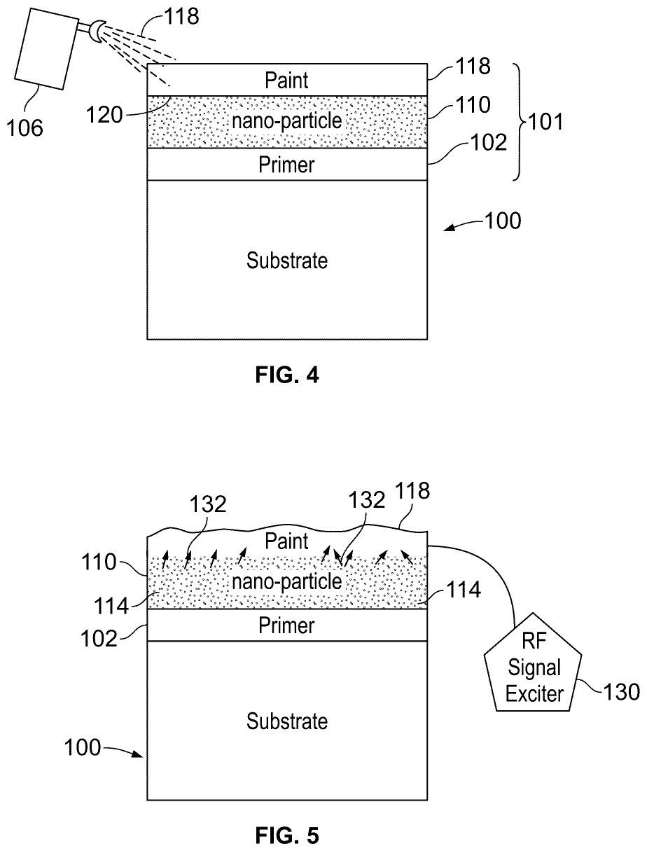

FIG. 4 illustrates a block diagram of a paint layer 118 applied over the nano-particle layer 110, according to an example of the present disclosure. After the nano-particle layer 110 is applied over the surface 112 of the primer 102, the paint layer 118 is applied over an exposed surface 120 of the nano-particle layer 110. The paint layer 118 can be applied by spraying. For example, the spray gun 106 can be used to spray the nano-particle layer 118 over the surface 120 of the nano-particle layer 110. Optionally, the paint layer 118 can be applied via other processes, such as brushing, immersing, or the like.

The paint layer 118 provides a topcoat layer of paint on the substrate 100. The nano-particle layer 110 is embedded underneath the paint layer 118 and above the primer 102. In at least one example, the nano-particle layer 110 is sandwiched between the primer 102 and the paint layer 118. Optionally, the nano-particle layer 110 can be distributed within and throughout the primer 102 and/or the paint layer 118.

The primer 102, the nano-particle layer 110, and the paint layer 118 provide a coating system 101 that coats the substrate 100. The nano-particle layer 110 is embedded within the coating system 101. For example, the nano-particle layer 110 is sandwiched between the primer 102 and the paint layer 118. As described herein, the coating system 101 is configured to allow the paint layer 118 to be efficiently and effectively removed from the substrate 100, if and when desired.

As described herein, a system includes the substrate 100 having the surface 104. The primer 102 is applied on the surface 104 of the substrate 100. The nano-particle layer 110 is applied over the primer 102. The paint layer 118 is applied over the nano-particle layer 110. In at least one example, the nano-particle layer 110 includes the carrier 116, and the nano-particles 114 suspended within the carrier 116. As described herein, the paint layer 118 is removed from the substrate 100 when a fluorescence of the nano-particle layer 110 is visible. That is, the fluorescence provides a visible indication that the paint layer 118 is removed (as the paint layer 118 no longer covers the fluorescing nano-particle layer 110).

FIG. 5 illustrates a block diagram of a radio frequency (RF) signal exciter 130 coupled to the paint layer 118, according to an example of the present disclosure. In order to remove the paint layer 118 from the substrate 100, the RF signal exciter 130 is coupled to a portion of the assembly, such the paint layer 118. Optionally, the RF signal exciter 130 can be coupled to another portion, such as the substrate 100. In at least one example, the RF signal exciter 130 does not contact the substrate 100, but is configured to excite the nano-particles 114 by outputting RF signals, such as radio waves. For example, the RF signal exciter 130 can be placed in close proximity (for example, within 5 feet or less) so that RF signals (for example, radio waves) emitted by the RF signal exciter 130 are able to excite the nano-particles 114 within the nano-particle layer 110. Alternatively, the RF signal exciter 130 can be coupled to the substrate 130 through one or more leads. As another example, the RF signal exciter 130 can abut against one or more portions of the substrate 100.

In order to remove the paint layer 118, the RF signal exciter 130 is activated to excite the nano-particles 114. In at least one example, the RF signal exciter 130 operates to emit radio waves at a frequency between 20-60 Gigahertz (GHz). Alternatively, the frequency can be less than 20 GHz or greater than 60 GHz. The radio waves are tuned to excite the nano-particles. In at least one example, the RF signal exciter emits the radio waves at the frequency for a period of 5-10 minutes. Optionally, the period can be less than 5 minutes (such as 2 minutes), or greater than 10 minutes (such as 20 minutes). The radio waves emitted by the RF signal exciter 130 excite the nano-particles 114, which generate heat in the direction of arrows 132. The radio waves align the nano-particles to generate the heat toward and into the paint layer 118 (and away from the primer 102), thereby melting and/or dissolving the paint layer 118, which is then easily removable from the substrate 100, while not affecting the primer 102. As such, the paint layer 118 is removed from the substrate 100, while the primer 102 remains on the substrate 100, which reduces waste (that is, the primer 102 can be used in relation to a new topcoat of paint).

As described herein, the nano-particle layer 110 is configured to be excited by signals (for example, radio waves) emitted by an energy source (for example, the RF signal exciter 130). The nano-particle layer 110 is further configured to generate heat when excited by the signals. The heat melts the paint layer 118. In at least one example, the heat generated by the nano-particle layer 110 is directed toward and into the paint layer 118, and optionally away from the primer 102 (thereby not affecting the primer 102, which can continue to be used with respect to a new layer of paint).

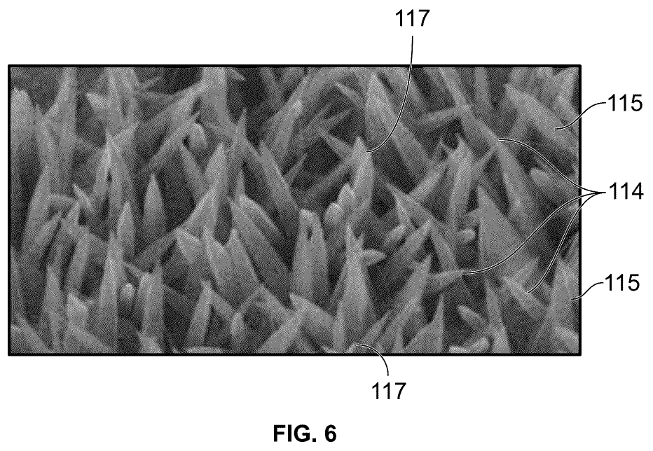

FIG. 6 illustrates a magnified perspective view of nano-particles 114, according to an example of the present disclosure. Referring to FIGS. 4-6, in at least one example, the nano-particles 114 can be metallic tubes 115 configured to align vertically when excited by signals output by the RF signal exciter 130. When excited by radio waves output by the RF signal exciter 130, the nano-particles 114 vertically align, and pointed ends 117 of the tubes 115 are oriented toward the paint layer 118 such that generated heat is directed toward the paint layer 118, and away from the primer 102.

In at least one example, the nano-particles 114 are configured to fluoresce in response to be being excited by the radio waves emitted by the RF signal exciter 130. A tuned bandgap of the nano-particles 114 can confirm paint removal through fluorescence, reducing the necessity for external sensors and analysis. Thus, as the paint layer 118 melts or dissolves away from the nano-particle layer 110, the fluorescence of the nano-particles 114 within the nano-particle layer 110 provides a readily discernible visual indication that the paint layer 118 has been removed. Accordingly, the RF signal exciter 130 can then be deactivated.

As described herein, examples of the present disclosure provide systems and methods for efficiently and effectively removing the paint layer 118 from the substrate 100. The nano-particle layer 110 embedded between the primer 102 and the paint layer 118 provides a low cost, safe, and environmentally-friendly, conditions-based agent for removing the paint layer 118. In at least one example, the nano-particle layer 110 includes a disbursed suspension of specifically-tuned nano-particles 114 in a carrier 116, such as an organic paint. When the nano-particles 114 are excited by signals output from an external energy source (such as radio waves emitted by the RF signal generator 130), the nano-particles 114 generate heat, which softens the adjacent paint layer 118, thereby simplifying removal of the paint layer 118.

The nano-particles 114 have a high surface area/volume ratio, and therefore reduced density and weight. Different nano-particles 114 can be used, as desired. For example, the nano-particles 114 are tunable based on material and processing considerations, and can be designed and implemented into various coating systems. In at least one example, the nano-particles 114 are configured to react to a non-contact energy source, such as the RF signal exciter 130, creating focused heat to aid in removal of the paint layer 118. The nano-particles 114 can be configured to induce a magnetic dipole to ensure adhesion to the substrate 100, and can be phase shifted to optimize paint removal.

It has been found that the systems and methods described herein: (a) improve paint removal rate and accuracy, (b) reduce maintenance costs of paint topcoat removal, (c) reduce environmental impact from paint topcoat removal, (d) reduce exposure to hazardous materials and energy, (e) reduce heat damage risk of laser ablation, and (f) improve reliability of ensuring complete paint topcoat removal.

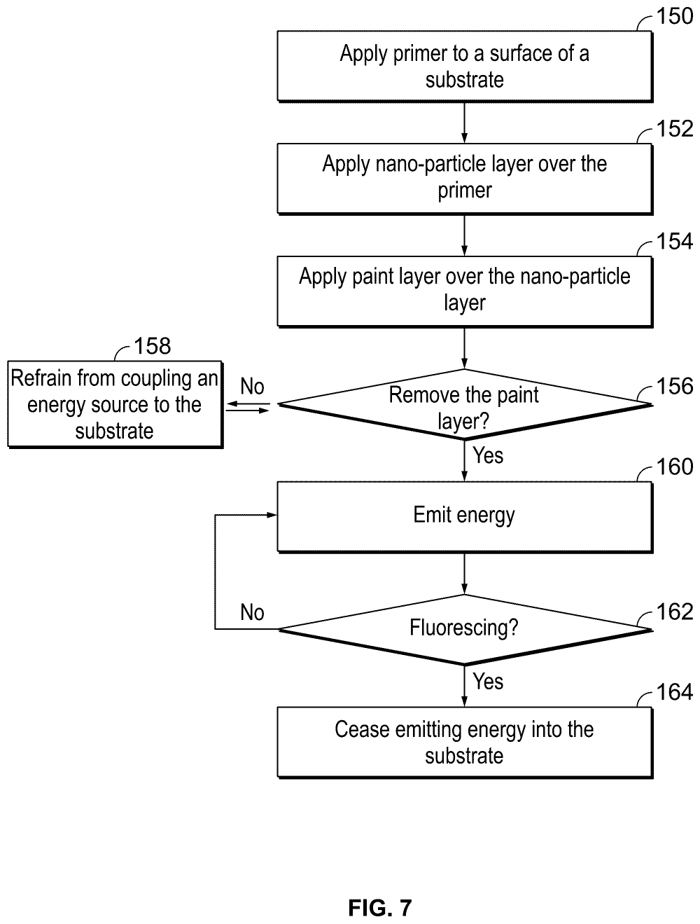

FIG. 7 illustrates a flow chart of a method, according to an example of the present disclosure. Referring to FIGS. 1-7, at 150, the primer 102 is first applied to the substrate 100. At 152, the nano-particle layer 110 is applied over the primer 102. Next, at 154, the paint layer 118 is applied over the nano-particle layer 110.

At 156, it is determined if the paint layer 118 is to be removed (such as if the paint layer 118 has degraded through normal wear and tear over time), If not, the method proceeds from 156 to 158, at which an operator refrains from coupling an energy source (such as the RF signal exciter 130) to the substrate 100.

If, however, the paint layer 118 is to be removed at 156, the method proceeds to 160, at which the energy source (such as the RF signal exciter 130) is coupled to the assembly (either directly or in close proximity), and is operated to emit energy (such as radio waves) into the substrate 100. The radio waves, for example, align the nano-particles 114 in a vertical configuration, and cause the nano-particles 114 to emit heat energy into the paint layer 118 (and optionally away from the primer 102), thereby melting, dissolving, or otherwise disbonding the paint layer 118. In at least one example, the nano-particles 114 also fluoresce when excited by the radio waves. As such, as the paint layer 118 is removed, a fluorescence is evident. Thus, at 162, an operator determines if the substrate 100 is fluorescing (by the exposed, excited nano-particles 114). If not, the method returns to the 160. If, however, the substrate 100 is fluorescing at 162, the method proceeds to 164, at which the energy is deactivated so that the energy (for example, the radio waves) ceases.

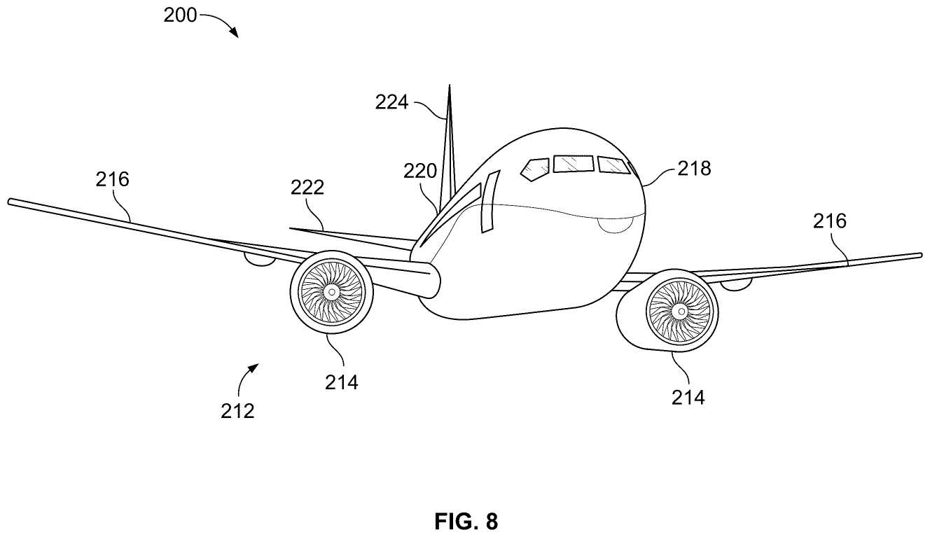

FIG. 8 illustrates a perspective front view of an aircraft 200, which has various external and/or internal surfaces that include coating systems 101 (shown in FIG. 4), as described herein. The aircraft 200 includes a propulsion system 212 that includes engines 214, for example. Optionally, the propulsion system 212 may include more engines 214 than shown. The engines 214 are carried by wings 216 of the aircraft 200. In other examples, the engines 214 may be carried by a fuselage 218 and/or an empennage 220. The empennage 220 may also support horizontal stabilizers 222 and a vertical stabilizer 224.

The fuselage 218 of the aircraft 200 defines an internal cabin, which includes a flight deck or cockpit, one or more work sections (for example, galleys, personnel carry-on baggage areas, and the like), one or more passenger sections (for example, first class, business class, and coach sections), one or more lavatories, and/or the like.

Optionally, instead of an aircraft, examples of the present disclosure can be used with various other types of vehicles. Suitable vehicles may include automobiles, buses, trucks, locomotives and train cars, watercraft, spacecraft, and the like. Also, optionally, examples of the present disclosure can be used with various fixed structures (such as residential or commercial buildings), components and devices (for example, appliances), and the like.

Further, the disclosure comprises examples according to the following clauses:
Clause 1. A system comprising:
a substrate having a surface;
a primer applied on the surface of the substrate;
a nano-particle layer applied over the primer; and
a paint layer applied over the nano-particle layer.
Clause 2. The system of Clause 1, wherein the nano-particle layer comprises:
a carrier; and
nano-particles suspended within the carrier.
Clause 3. The system of Clauses 1 or 2, wherein the substrate is a structure of an aircraft.
Clause 4. The system of any of Clauses 1-3, wherein the nano-particle layer is applied over the primary by a spray gun.
Clause 5. The system of any of Clauses 1-4, wherein the nano-particle layer is sandwiched between the primer and the paint layer.
Clause 6. The system of any of Clauses 1-5, wherein the nano-particle layer is configured to be excited by signals emitted by an energy source, wherein the nano-particle layer is further configured to generate heat when excited by the signals, and wherein the heat removes the paint layer.
Clause 7. The system of Clause 6, wherein the heat generated by the nano-particle layer is directed toward and into the paint layer.
Clause 8. The system of Clause 7, wherein the heat generated by the nano-particle layer is directed away from the primer.
Clause 9. The system of any of Clauses 6-8, wherein the nano-particle layer is further configured to fluoresce when excited by the signals.
Clause 10. The system of Clause 9, wherein the paint layer is removed from the substrate when a fluorescence of the nano-particle layer is visible.
Clause 11. The system of any of Clauses 6-10, wherein the energy source comprises a radio frequency (RF) signal exciter, and wherein the signals comprise radio waves.
Clause 12. A method comprising:
applying a primer applied on a surface of a substrate;
applying a nano-particle layer over the primer; and
applying a paint layer over the nano-particle layer.
Clause 13. The method of Clause 12, wherein the nano-particle layer comprises:
a carrier; and
nano-particles suspended within the carrier.
Clause 14. The method of Clauses 12 or 13, wherein said applying the nano-particle layer comprises spaying the nano-particle layer onto the primer.
Clause 15. The method of any of clauses 12-14, wherein the nano-particle layer is sandwiched between the primer and the paint layer.
Clause 16. The method of any of Clauses 12-15, further comprising:
emitting signals, by an energy source, into the substrate;
exciting the nano-particle layer by the signals;
generating heat by the nano-particle layer in response to said exciting; and removing the paint layer by the heat.
Clause 17. The method of Clause 16, wherein the heat is directed toward and into the paint layer, and away from the primer.
Clause 18. The method of Clauses 16 or 17, wherein said exciting further causes the nano-particle layer to fluoresce, wherein said removing is complete when the fluorescence of the nano-particle layer is visible.
Clause 19. The method of any of Clauses 16-18, wherein the energy source comprises a radio frequency (RF) signal exciter, and wherein the signals comprise radio waves.
Clause 20. A method for removing a paint layer from a substrate, the method comprising:
emitting signals, by an energy source, into the substrate;
exciting a nano-particle layer by the signals;
generating heat by the nano-particle layer in response to said exciting; and
removing the paint layer by the heat.

As described herein, examples of the present disclosure provide efficient and effective systems and methods for removing paint from a structure. Further, examples of the present disclosure provide systems and methods for removing paint that do not undesirably affect an underlying primer and structure.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a substrate having a surface;
a primer applied on the surface of the substrate;
a nano-particle layer applied over the primer; and
a paint layer applied over the nano-particle layer.

2. The system of claim 1, wherein the nano-particle layer comprises:
a carrier; and
nano-particles suspended within the carrier.

3. The system of claim 1, wherein the substrate is a structure of an aircraft.

4. The system of claim 1, wherein the nano-particle layer is applied over the primary by a spray gun.

5. The system of claim 1, wherein the nano-particle layer is sandwiched between the primer and the paint layer.

6. The system of claim 1, wherein the nano-particle layer is configured to be excited by signals emitted by an energy source, wherein the nano-particle layer is further configured to generate heat when excited by the signals, and wherein the heat removes the paint layer.

7. The system of claim 6, wherein the heat generated by the nano-particle layer is directed toward and into the paint layer.

8. The system of claim 7, wherein the heat generated by the nano-particle layer is directed away from the primer.

9. The system of claim 6, wherein the nano-particle layer is further configured to fluoresce when excited by the signals.

10. The system of claim 9, wherein the paint layer is removed from the substrate when a fluorescence of the nano-particle layer is visible.

11. The system of claim 6, wherein the energy source comprises a radio frequency (RF) signal exciter, and wherein the signals comprise radio waves.

12. A method comprising:
applying a primer applied on a surface of a substrate;
applying a nano-particle layer over the primer; and
applying a paint layer over the nano-particle layer.

13. The method of claim 12, wherein the nano-particle layer comprises:
a carrier; and
nano-particles suspended within the carrier.

14. The method of claim 12, wherein said applying the nano-particle layer comprises spaying the nano-particle layer onto the primer.

15. The method of claim 12, wherein the nano-particle layer is sandwiched between the primer and the paint layer.

16. The method of claim 12, further comprising:
emitting signals, by an energy source, into the substrate;
exciting the nano-particle layer by the signals;
generating heat by the nano-particle layer in response to said exciting; and
removing the paint layer by the heat.

17. The method of claim 16, wherein the heat is directed toward and into the paint layer, and away from the primer.

18. The method of claim 16, wherein said exciting further causes the nano-particle layer to fluoresce, wherein said removing is complete when the fluorescence of the nano-particle layer is visible.

19. The method of claim 16, wherein the energy source comprises a radio frequency (RF) signal exciter, and wherein the signals comprise radio waves.

20. A method for removing a paint layer from a substrate, the method comprising:
emitting signals, by an energy source, into the substrate;
exciting a nano-particle layer by the signals;
generating heat by the nano-particle layer in response to said exciting; and
removing the paint layer by the heat.
